(19) United States
(12) Patent Application Publication
(10) Pub. No.: US 2026/0325978 A1
(43) Pub. Date: Oct. 22, 2026

(54) FULL-WRAP PROTECTIVE CASE WITH GOOD CONNECTION STABILITY

(71) Applicant: Shenzhen Deone Innovation Technology Co., Ltd, Shenzhen (CN)

(72) Inventors: HUAYONG XIE, Zhanjiang (CN); LEI YU, Shenzhen (CN); QIANG LIU, Jingzhou (CN)

(21) Appl. No.: 19/719,025

(22) Filed: Jun. 24, 2026

(30) Foreign Application Priority Data
Aug. 7, 2025 (CN) 202521671449.0

(51) Int. Cl. A63F 13/98

(52) U.S. Cl. CPC A63F 13/98

(57) ABSTRACT

A full-wrap protective case with good connection stability includes a first shell, a second shell and a slider. The slider is slidably arranged on the first shell or the second shell. In a locked state, the slider is engaged with the first shell and the second shell. The slider is provided with a first engaging portion, the first shell and/or the second shell is provided with a second engaging portion, and when the slider is located in a first position, the first engaging portion is engaged with the second engaging portion to restrain the slider from sliding, such that the slider is maintained at the first position and prevented from moving to a second position due to a collision, i.e., the protective case is prevented from being unlocked due to a collision, thereby improving the connection stability of the first shell and the second shell.

### CROSS-REFERENCE TO RELATED APPLICATIONS

This application claims priority to Chinese Patent Application No. 2025216714490, filed on Aug. 7, 2025, which is hereby incorporated by reference in its entirety.

### TECHNICAL FIELD

The present disclosure relates to the technical field of electronics accessories, in particular to a full-wrap protective case with good connection stability.

### BACKGROUND

Electronic devices are easily damaged due to collisions, so they are often housed in protective cases. Generally, the protective case for an electronic device adopts a combined structure of two shells, the two shells define a receiving chamber and the electronic device is received in the receiving chamber.

The two shells may be connected in various ways. For example, each of the two shells is provided with a connector, and a slider is slidably arranged on one of the connectors. In a locked state, the slider is located in a first position and engaged with the two connectors so as to connect the two shells. In an unlocked state, the slider is located in a second position, and the slider is disengaged from one of the connectors.

When the protective case is carried, the slider may slide due to collisions, causing the slider to move from the first position to the second position, i.e., the protective case is switched from the locked state into the unlocked state. Under the action of a collision, the two shells of the protective case move relatively, causing the connection between the first shell and the second shell to become insecure, which in turn leads to exposure of the electronic device, thus making the protective case unable to provide stable protection for the electronic device.

### SUMMARY

In view of the defects and deficiencies in the prior art, an objective of the present disclosure is to provide a full-wrap protective case with good connection stability. A slider is provided with a first engaging portion, a first connector and/or a second connector is provided with a second engaging portion, and when the slider is located in a first position, the first engaging portion is engaged with the second engaging portion to maintain the slider at the first position, such that the slider is prevented from moving to a second position due to a collision, i.e., the full-wrap protective case is prevented from being unlocked due to a collision.

To fulfill the above objective, the technical solution adopted by the present disclosure is as follows: a full-wrap protective case with good connection stability includes a first shell, a second shell and a slider, where the slider is slidably arranged on the first shell or the second shell, and in a locked state, the slider is engaged with the first shell and the second shell; the slider is provided with a first engaging portion, the first shell and/or the second shell is provided with a second engaging portion, and when the slider is located in a first position, the first engaging portion is engaged with the second engaging portion to restrain the slider from sliding.

By adopting the above technical solution, the present disclosure fulfills the following beneficial effects: the slider is provided with the first engaging portion, the first shell and/or the second shell is provided with the second engaging portion, and when the slider is located in the first position, the first engaging portion is engaged with the second engaging portion to maintain the slider at the first position, such that the slider is prevented from moving to a second position due to a collision, i.e., the full-wrap protective case is prevented from being unlocked due to a collision, thereby improving the connection stability of the first shell and the second shell.

### BRIEF DESCRIPTION OF DRAWINGS

To more clearly explain the technical solutions in the embodiments of the present disclosure or the prior art, drawings used for describing the embodiments of the present disclosure or the prior art are briefly introduced below. Obviously, the drawings in the following description merely illustrate some embodiments of the present disclosure, and for those ordinarily skilled in the art, other drawings may be obtained on the basis of the following ones without creative labor.

FIG. 1 is a schematic structural diagram of a full-wrap protective case in an unlocked state according to an embodiment of the present disclosure.

FIG. 2 is a schematic structural diagram of the full-wrap protective case in a locked state according to an embodiment of the present disclosure.

FIG. 3 is a schematic structural diagram of the full-wrap protective case in an unfolded state according to an embodiment of the present disclosure.

FIG. 4 is a sectional view along A-A′ in FIG. 1.

FIG. 5 is a sectional view along B-B′ in FIG. 2.

FIG. 6 is a sectional view along C-C′ in FIG. 2.

FIG. 7 is a sectional view along D-D′ in FIG. 2.

FIG. 8 is a sectional view along E-E′ in FIG. 2.

FIG. 9 is a schematic structural diagram of an elastic engaging part according to an embodiment of the present disclosure.

### REFERENCE SIGNS

1000, full-wrap protective case; 100, first shell; 110, first connector; 111, first extension unit; 1111, second engaging portion; 11111, third guide slope; 112, first engaging unit; 113, stop portion; 120, first soft pad; 200, second shell; 210, second connector; 211, second extension unit; 212, second engaging unit; 220, elastic engaging part; 221, engaging protrusion; 222, avoidance space; 223, avoidance groove; 230, second soft pad; 240, slot; 300, slider; 310, main body; 320, third extension unit; 330, third engaging unit; 331, first engaging portion; 3311, second guide slope; 332, first guide slope; 333, sliding protrusion; 400, receiving chamber; 500, electronic device; X, first direction; Y, second direction; Z, third direction.

### DESCRIPTION OF EMBODIMENTS

The present disclosure is described in further detail below in conjunction with the accompanying drawings.

The following specific embodiment is merely used for explaining the present disclosure rather than limiting the present disclosure. After reading the specification, those skilled in the art may make non-creative modifications to this embodiment as needed, and all these non-creative modifications within the scope of the claims of the present disclosure are protected by the patent law.

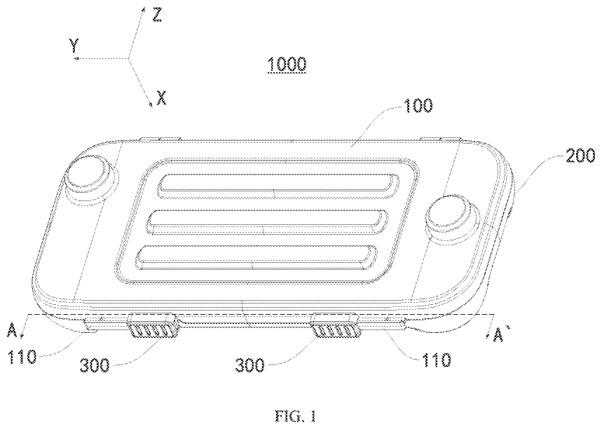

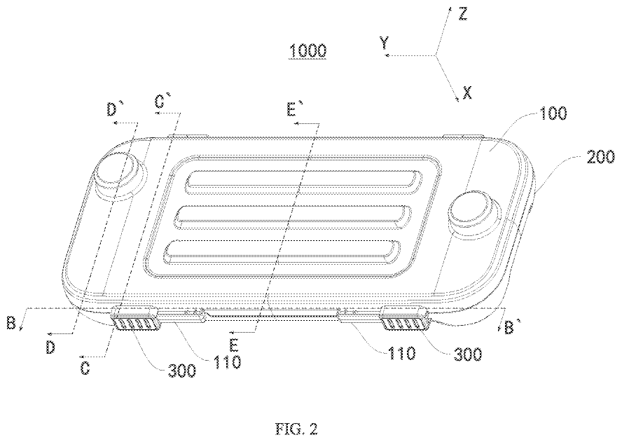

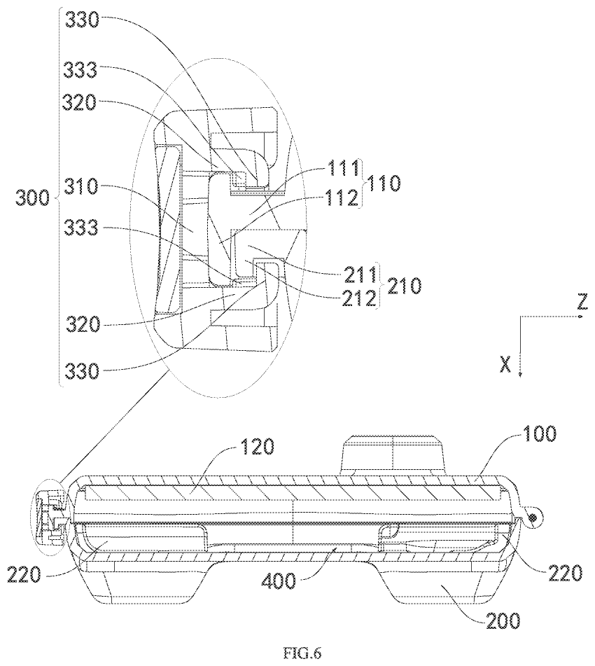

As shown in FIGS. 1-8, this embodiment relates to a full-wrap protective case 1000 with good connection stability. The full-wrap protective case 1000 includes a first shell 100, a second shell 200 and a slider 300. The first shell 100 and the second shell 200 define a receiving chamber 400 jointly, and the receiving chamber 400 is used for receiving an electronic device 500.

The slider 300 is slidably arranged on the first shell 100 or the second shell 200. In a locked state, the slider 300 is engaged with the first shell 100 and the second shell 200. The slider 300 is provided with a first engaging portion 331, and the first shell 100 and/or the second shell 200 is provided with a second engaging portion 1111. When the slider 300 is located in a first position, the first engaging portion 331 is engaged with the second engaging portion 1111 to restrain the slider 300 from sliding.

In an implementation mode, the first shell 100 is provided with a first connector 110, and the second shell 200 is provided with a second connector 210. The slider 300 is slidably arranged on the first connector 110 or the second connector 210. In the locked state, the slider 300 is located in the first position, and the slider 300 is engaged with the first connector 110 and the second connector 210, i.e., the slider 300 is engaged with the first shell 100 and the second shell 200, such that the first shell 100 and the second shell 200 are locked together to fully wrap around the electronic device 500. In an unlocked state, the slider 300 is located in a second position, and the slider 300 is disengaged from the first connector 110 or the second connector 210, i.e., the slider 300 is disengaged from the first shell 100 or the second shell 200, such that the first shell 100 and the second shell 200 are movable with respect to each other to be unfolded, so as to expose the electronic device 500.

As shown in FIGS. 1-6, the slider 300 is provided with the first engaging portion 331, and the first connector 110 and/or the second connector 210 is provided with the second engaging portion 1111. When the slider 300 is located in the first position, i.e., when the full-wrap protective case 1000 is in the locked state, the first engaging portion 331 is engaged with the second engaging portion 1111 to restrain the slider 300 from sliding (to be specific, to restrain the slider 300 from sliding from the first position to the second position) to improve the stability of the full-wrap protective case 1000 in the locked state, such that the first shell 100 and the second shell 200 can provide stable protection for the electronic device 500.

The electronic device 500 is one of a game console, a tablet computer, a mobile phone and a notebook computer. In this embodiment, the electronic device 500 is a game console.

In an implementation mode, as shown in FIGS. 1-6, the slider 300 is slidably arranged on the first connector 110, and the second engaging portion 1111 is arranged on the first connector 110. When the slider 300 is located in the first position, the first engaging portion 331 of the slider 300 is engaged with the second engaging portion 1111 of the first connector 110 to restrain the slider 300 from sliding. When the slider 300 is located in the second position, the slider 300 is disengaged from the second connector 210, such that the first shell 100 and the second shell 200 are movable with respect to each other to expose the electronic device 500.

In another implementation mode, the slider 300 is slidably arranged on the first connector 110, and the second engaging portion 1111 is arranged on the second connector 210. When the slider 300 is located in the first position, the first engaging portion 331 of the slider 300 is engaged with the second engaging portion 1111 of the second connector 210 to restrain the slider 300 from sliding. When the slider 300 is located in the second position, the slider 300 is disengaged from the second connector 210, such that the first shell 100 and the second shell 200 are movable with respect to each other to expose the electronic device 500.

In another implementation mode, the slider 300 is slidably arranged on the first connector 110, two second engaging portions 1111 are respectively arranged on the first connector 110 and the second connector 210, and correspondingly, the slider 300 is provided with two first engaging portions 331. When the slider 300 is located in the first position, the two first engaging portions 331 of the slider 300 are respectively engaged with the second engaging portion 1111 of the second connector 210 and the second engaging portion 1111 of the first connector 110 to restrain the slider 300 from sliding. When the slider 300 is located in the second position, the slider 300 is disengaged from the second connector 210, such that the first shell 100 and the second shell 200 are movable with respect to each other to expose the electronic device 500.

In another implementation mode, the slider 300 is slidably arranged on the second connector 210, and the second engaging portion 1111 is arranged on the first connector 110. When the slider 300 is located in the first position, the first engaging portion 331 of the slider 300 is engaged with the second engaging portion 1111 of the first connector 110 to restrain the slider 300 from sliding. When the slider 300 is located in the second position, the slider 300 is disengaged from the first connector 110, such that the first shell 100 and the second shell 200 are movable with respect to each other to expose the electronic device 500.

In another implementation mode, the slider 300 is slidably arranged on the second connector 210, and the second engaging portion 1111 is arranged on the second connector 210. When the slider 300 is located in the first position, the first engaging portion 331 of the slider 300 is engaged with the second engaging portion 1111 of the second connector 210 to restrain the slider 300 from sliding. When the slider 300 is located in the second position, the slider 300 is disengaged from the first connector 110, such that the first shell 100 and the second shell 200 are movable with respect to each other to expose the electronic device 500.

In another implementation mode, the slider 300 is slidably arranged on the second connector 210, two second engaging portions 1111 are arranged on the first connector 110 and the second connector 210 respectively, and correspondingly, the slider 300 is provided with two first engaging portions 331. When the slider 300 is located in the first position, the two first engaging portions 331 of the slider 300 are respectively engaged with the second engaging portion 1111 on the second connector 210 and the second engaging portion 1111 on the first connector 110 to restrain the slider 300 from sliding. When the slider 300 is located in the second position, the slider 300 is disengaged from the first connector 110, such that the first shell 100 and the second shell 200 are movable with respect to each other to expose the electronic device 500.

In an implementation mode, two or more first connectors 110 are arranged, and the number of second connectors 210 and the number of sliders 300 correspond to the number of the first connectors 110. At least two first connectors 110 are respectively arranged at two opposite ends of the first shell 100 to guarantee the connection stability of the first shell 100 and the second shell 200 in the locked state, thereby guaranteeing the protection performance of the full-wrap protective case 1000.

In this embodiment, two first connectors 110 are arranged, and the number of second connectors 210 and the number of sliders 300 correspond to the number of the first connectors 110, i.e., the number of the second connectors 210 is two, and the number of the sliders 300 is two. The two first connectors 110 are located on a same side of the first shell 100 to guarantee the connection performance of the first shell 100 and the second shell 200 on this side.

As shown in FIGS. 1, 3 and 6, an end, away from the first connector 110, of the first shell 100 is rotatably connected to an end, away from the second connector 210, of the second shell 200, i.e., an end, away from the slider 300, of the first shell 100 is rotatably connected to an end, away from the slider 300, of the second shell 200. By articulating one end of the first shell 100 with one end of the second shell 200 and slidably engaging the other end of the first shell 100 with the other end of the second shell 200, the protection performance of the full-wrap protective case 1000 is guaranteed, thereby guaranteeing the connection stability of the first shell 100 and the second shell 200 in the locked state, and facilitating state switching of the full-wrap protective case 1000.

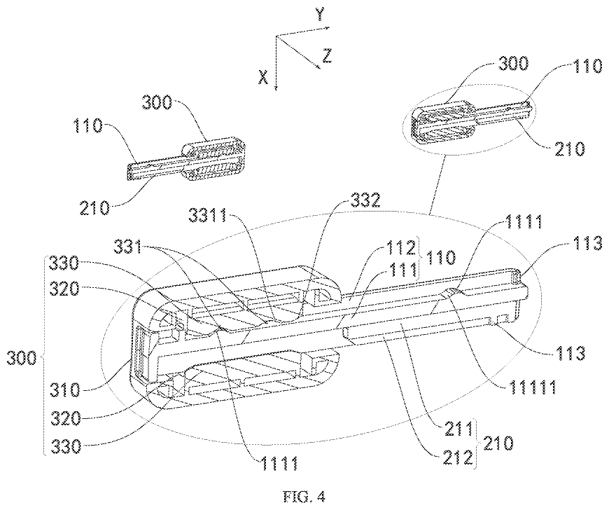

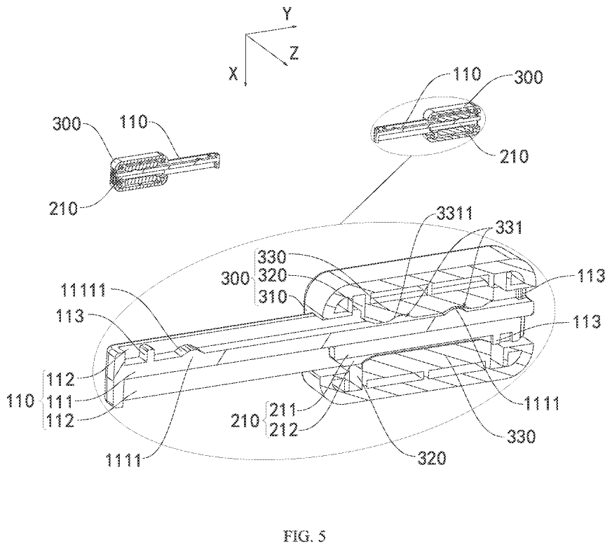

As shown in FIGS. 4-5, two second engaging portions 1111 are arranged. When the slider 300 is located in the second position, the slider 300 is disengaged from the first shell 100 or the second shell 200, i.e., the slider 300 is disengaged from the first connector 110 or the second connector 210, and one of the second engaging portions 1111 is engaged with the first engaging portion 331. When the slider 300 is located in the first position, the other second engaging portion 1111 is engaged with the first engaging portion 331. By means of the arrangement of the two second engaging portions 1111, when the slider 300 is located in the second position, the other second engaging portion 1111 is engaged with the first engaging portion 331, such that the slider 300 is prevented from sliding in the unlocked state.

As shown in FIGS. 4-5, two first engaging portions 331 are arranged. When the slider 300 is located in the second position, one of the first engaging portions 331 is engaged with one of the second engaging portions 1111. When the slider 300 is located in the first position, the other first engaging portion 331 is engaged with the other second engaging portion 1111. By means of the arrangement of the two first engaging portions 331, the two first engaging portions 331 may be kept away from each other, i.e., the two first engaging portions 331 are arranged close to two opposite ends of the slider 300 respectively, such that the distance from the first engaging portions 331 to the respective end of the slider 300 closest thereto is reduced, thereby reducing the movement distance required for engaging the second engaging portions 1111 with the first engaging portions 331; moreover, the size of the slider 300 in the length direction is increased to facilitate operation by users (to be specific, users may slide the slider 300 easily).

As shown in FIGS. 4-6, the movement direction of one slider 300 is defined as a second direction Y, and the second direction Y specifically refers to a direction in which the slider 300 moves from the second position to the first position; and the movement direction of the other slider 300 from the second position to the first position is an opposite direction of the second direction Y. Second guide slopes 3311 are formed at two opposite ends of the first engaging portion 331 in the second direction Y. Third guide slopes 11111 are formed at two opposite ends of the second engaging portion 1111 in the second direction Y. By means of the arrangement of the second guide slopes 3311 and the third guide slopes 11111, the first engaging portion 331 may be easily separated from the second engaging portion 1111. The slider 300 is provided with a third engaging unit 330, the first engaging portion 331 is arranged on the third engaging unit 330, and first guide slopes 332 are formed at two opposite ends of the third engaging unit 330 in the second direction Y. By means of the arrangement of the first guide slopes 332, the second engaging portion 1111 may be easily inlaid into the space between the third engaging unit 330 and the first shell 100 or the second shell 200, thereby facilitating the engagement between the first engaging portion 331 and the second engaging portion 1111.

In an implementation mode, the direction from the first shell 100 to the second shell 200 is defined as a first direction X. The first connector 110 includes a first extension unit 111 and a first engaging unit 112. The first engaging unit 112 is arranged at an end, away from the first shell 100, of the first extension unit 111 and extends in an opposite direction of the first direction X. The second connector 210 includes a second extension unit 211 and a second engaging unit 212. The second engaging unit 212 is arranged at an end, away from the second shell 200, of the second extension unit 211 and extends in the first direction X. The slider 300 includes a main body 310, two third extension units 320 and two third engaging units 330. The two third extension units 320 are arranged on a side, facing the first shell 100, of the main body 310 and are respectively close to two opposite ends of the main body 310 in the first direction X. The two third engaging units 330 are respectively arranged at ends, away from the main body 310, of the two third extension units 320 and extend towards each other. The slider 300 is slidably arranged on the first connector 110, the second engaging portion 1111 is arranged on the first extension unit 111, and the first engaging portion 331 is arranged on the third engaging unit 330 close to the first connector 110.

The first direction X is a thickness direction of the full-wrap protective case 1000. The movement direction of one slider 300 from the second position to the first position is defined as a second direction Y, the movement direction of the other slider 300 from the second position to the first position is an opposite direction of the second direction Y, and the second direction Y is a length direction of the full-wrap protective case 1000.

In this embodiment, each of the two third engaging units 330 is provided with a sliding protrusion 333, and the sliding protrusions 333 extend towards the main body 310. The first connector 110 is T-shaped, i.e., at least a portion of the first engaging unit 112 extends in the first direction X, and at least a portion of the first engaging unit 112 extends in the opposite direction of the first direction X. When the slider 300 is assembled on the first connector 110, the first engaging unit 112 of the first connector 110 is clamped by the sliding protrusions 333 and the main body 310, such that the slider 300 is restrained from moving in a third direction Z or is restrained from moving in an opposite direction of the third direction Z.

As shown in FIGS. 4-5, in an implementation mode, when the slider 300 is located in the second position, i.e., in the unlocked state, the slider 300 is disengaged from the first connector 110 or the second connector 210. The movement direction of one slider 300 from the second position to the first position is defined as a second direction Y. The first engaging portion 331 is a groove, the second engaging portion 1111 is a protrusion, and first guide slopes 332 are formed at two opposite ends of the third engaging unit 330 in the second direction Y, such that the protrusion may be easily inlaid in the space below the third engaging unit 330. Second guide slopes 3311 are formed on two opposite sides of the groove in the second direction Y, such that the protrusion may be easily disengaged from the groove. Third guide slopes 11111 are formed on two opposite sides of the second engaging portion 1111 in the second direction Y, such that the protrusion may be easily engaged into the groove and easily disengaged from the groove.

In another implementation mode, when the slider 300 is located in the second position, i.e., in the unlocked state, the slider 300 is disengaged from the first connector 110 or the second connector 210. The movement direction of the slider 300 from the second position to the first position is defined as a second direction Y. The first engaging portion 331 is a protrusion, the second engaging portion 1111 is provided with a groove, and first guide slopes 332 are formed at two opposite ends of the second engaging portion 1111 in the second direction Y, such that the protrusion may be easily inlaid into the space above the second engaging portion 1111. Second guide slopes 3311 are formed on two opposite sides of the groove in the second direction Y, such that the protrusion may be easily disengaged from the groove. Third guide slopes 11111 are formed on two opposite sides of the protrusion in the second direction Y, such that the protrusion may be easily inlaid in the groove and easily disengaged from the groove.

As shown in FIGS. 4-5, when the slider 300 is located in the second position, the slider 300 is disengaged from the first connector 110 or the second connector 210. The movement direction of one slider 300 from the second position to the first position is defined as a second direction Y. A stop portion 113 is arranged at each of two opposite ends of the first shell 100 or the second shell 200 in the second direction Y, i.e., a stop portion 113 is arranged at each of two opposite ends of the first connector 110 or the second connector 210 in the second direction Y, and the stop portions 113 are used for preventing disengagement of the slider 300.

In an implementation mode, the stop portion 113 at one end of the first connector 110 in the second direction Y is used for preventing disengagement of the slider 300 caused by excessive displacement when the slider 300 is switched from the unlocked state into the locked state. The stop portion 113 at one end of the first connector 110 in the opposite direction of the second direction Y is used for preventing disengagement of the slider 300 when the slider 300 is switched from the locked state into the unlocked state.

In this embodiment, the slider 300 is slidably arranged on the first connector 110, a stop portion 113 is arranged at each of two opposite ends of the first connector 110 in the second direction Y, and the stop portions 113 are used for preventing disengagement of the slider 300.A stop portion 113 is arranged at one end of the second connector 210 in the second direction Y and is used for preventing disengagement of the slider 300 caused by excessive displacement when the slider 300 is switched from the unlocked state into the locked state.

In another implementation mode, the slider 300 is slidably arranged on the second connector 210, and a stop portion 113 is arranged at each of two opposite ends of the second connector 210 in the second direction Y and is used for preventing disengagement of the slider 300.A stop portion 113 is arranged at one end of the first connector 110 in the second direction Y and used for preventing disengagement of the slider 300 caused by excessive displacement when the slider 300 is switched from the unlocked state into the locked state.

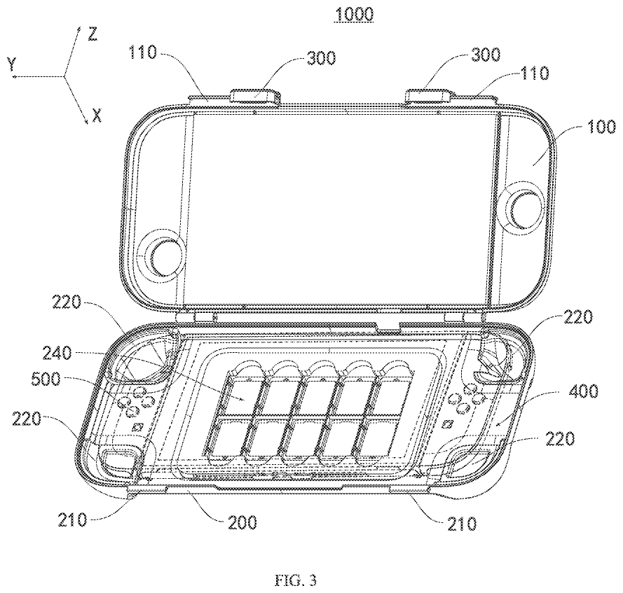

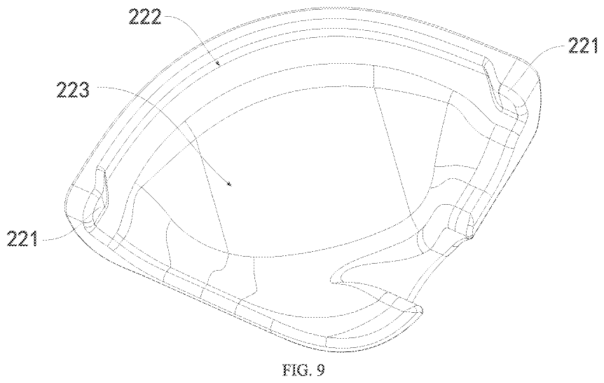

As shown in FIGS. 3 and 6-9, the first shell 100 or the second shell 200 is provided with elastic engaging parts 220, and the elastic engaging parts 220 are engaged with two opposite ends of the electronic device 500 in the length direction, i.e., the elastic engaging parts 220 are engaged with two opposite ends of the electronic device 500 in the second direction Y. The elastic engaging parts 220 may also be engaged with two opposite ends of the electronic device 500 in the width direction, i.e., the elastic engaging parts 220 may also be engaged with two opposite ends of the electronic device 500 in the third direction Z. The third direction Z is perpendicular to the first direction X and is also perpendicular to the second direction Y.

In this embodiment, four elastic engaging parts 220 are arranged on a side, close to the receiving chamber 400, of the second shell 200 and located at four corners of the second shell 200 respectively, thereby preventing the electronic device 500 from colliding with the shell during impact and avoiding damage to the electronic device 500.

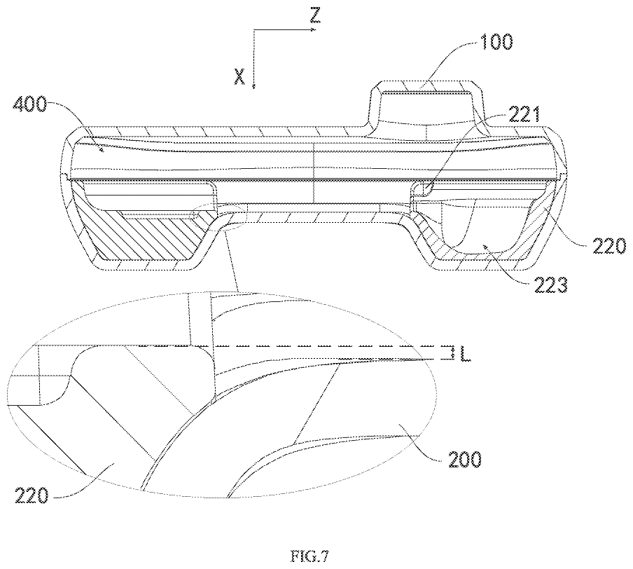

In addition, as shown in FIGS. 7-9, considering that keys are arranged on side surfaces of the electronic device 500, the elastic engaging part 220 is provided with at least two engaging protrusions 221, the engaging protrusions 221 are engaged with a housing of the electronic device 500, an avoidance space 222 is formed between every two engaging protrusions 221, and the avoidance space 222 is used for avoiding the keys arranged on the side surfaces of the electronic device 500, such that the keys are prevented from being accidentally pressed when the electronic device 500 is assembled onto the second shell 200.

In an implementation mode, some of the elastic engaging parts 220 are provided with avoidance grooves 223 used for avoiding the keys of the electronic device 500.

In another implementation mode, the elastic engaging part 220 is ring-shaped, arranged on a side, close to the receiving chamber 400, of the second shell 200, and engaged with the periphery of the electronic device 500.

In another implementation mode, four elastic engaging parts 220 are arranged on a side, close to the receiving chamber 400, of the second shell 200, where two of the four elastic engaging parts 220 are respectively arranged at two opposite ends of the second shell 200 in the second direction Y and engaged with two opposite ends of the electronic device 500 in the second direction Y, and the other two elastic engaging parts 220 are respectively arranged at two opposite ends of the second shell 200 in the third direction Z and engaged with two opposite ends of the electronic device 500 in the third direction Z.

As shown in FIGS. 3, 6 and 8, a first soft pad 120 is arranged on an inner side of the first shell 100, and a second soft pad 230 is arranged on an inner side of the second shell 200. In the storage state, the first soft pad 120 and the second soft pad 230 respectively abut against two opposite ends of the electronic device 500 in the thickness direction, where the thickness direction is the first direction X. The elastic engaging parts 220 are engaged with the two opposite ends of the electronic device 500 in the second direction Y and also engaged with the two opposite ends of the electronic device 500 in the third direction Z and the first soft pad 120 and the second soft pad 230 abut against the two opposite ends of the electronic device 500 in the first direction X, such that the electronic device 500 is protected in all directions.

In this embodiment, as shown in FIGS. 3 and 6-8, a height difference H between one end of the second soft pad 230 in the opposite direction of the first direction X and one end of the second shell 200 close to the receiving chamber 400 is greater than a height difference between bottom surfaces of the elastic engaging parts 220 and one end of the second shell 200 close to the receiving chamber 400, such that when the electronic device 500 is assembled on the second shell 200, one side of the electronic device 500 in the first direction X abuts against the second soft pad 230 first, i.e., one side of the electronic device 500 in the first direction X is prevented from coming into contact with the second shell 200, thereby protecting the electronic device 500 against damage by a collision. Moreover, by means of the arrangement of the elastic engaging parts 220, the second soft pad 230 will first come into contact with the elastic engaging parts 220 when deforming, to further prevent one side of the electronic device 500 in the first direction X from coming into contact with the second shell 200, thus protecting the electronic device 500 against damage caused by a collision.

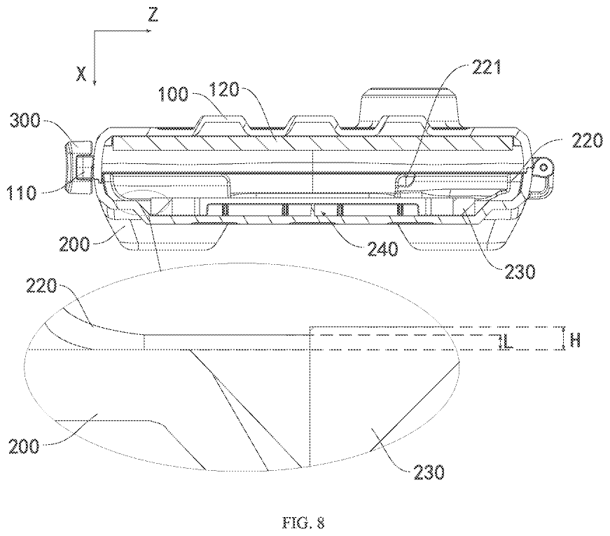

As shown in FIGS. 3 and 8, slots 240 are formed in the inner side of the second shell 200, and the slots 240 are used for storing electronic cards. In an implementation mode, an avoidance hole is formed in the second soft pad 230, and the slots 240 are formed in a space defined by the avoidance hole and the second shell 200 to store the electronic cards. The electronic cards include a game card and a memory card.

The above embodiment is merely used for explaining the technical solution of the present disclosure rather than limiting the present disclosure. Other modifications or equivalent substitutions made by those ordinarily skilled in the art without departing from the spirit and scope of the technical solution of the present disclosure should also fall within the scope of the claims of the present disclosure.

What is claimed is:

1. A full-wrap protective case with good connection stability, comprising a first shell, a second shell and a slider, the slider being slidably arranged on the first shell or the second shell, and in a locked state, the slider being engaged with the first shell and the second shell, wherein the slider is provided with a first engaging portion, the first shell and/or the second shell is provided with a second engaging portion, and when the slider is located in a first position, the first engaging portion is engaged with the second engaging portion to restrain the slider from sliding.

2. The full-wrap protective case according to claim 1, wherein an end, away from the slider, of the first shell is rotatably connected to an end, away from the slider, of the second shell.

3. The full-wrap protective case according to claim 1, wherein two said second engaging portions are arranged; when the slider is located in a second position, the slider is disengaged from the first shell or the second shell, and one of the second engaging portions is engaged with the first engaging portion; and when the slider is located in the first position, the other second engaging portion is engaged with the first engaging portion.

4. The full-wrap protective case according to claim 3, wherein two said first engaging portion are arranged; when the slider is located in the second position, one of the first engaging portions is engaged with the second engaging portion; and when the slider is located in the first position, the other first engaging portion is engaged with the other second engaging portion.

5. The full-wrap protective case according to claim 4, wherein the two first engaging portions are arranged away from each other and respectively close to two opposite ends of the slider.

6. The full-wrap protective case according to claim 1, wherein the first shell is provided with a first connector, the second shell is provided with a second connector, and the slider is slidably arranged on the first connector or the second connector; when the slider is located in the first position, the slider is engaged with the first connector and the second connector, and the second engaging portion is arranged on the first connector and/or the second connector.

7. The full-wrap protective case according to claim 1, wherein a movement direction of the slider is defined as a second direction, and second guide slopes are formed at two opposite ends of the first engaging portion in the second direction; and third guide slopes are formed at two opposite ends of the second engaging portion in the second direction.

8. The full-wrap protective case according to claim 1, wherein a movement direction of the slider is defined as a second direction, the slider is provided with a third engaging unit, the first engaging portion is arranged on the third engaging unit, and first guide slopes are formed at two opposite ends of the third engaging unit in the second direction.

9. The full-wrap protective case according to claim 6, wherein a direction from the first shell to the second shell is defined as a first direction, a movement direction of the slider is defined as a second direction, and a third direction is perpendicular to the first direction and is also perpendicular to the second direction;
the slider comprises a main body, two third extension units and two third engaging units, and the two third extension units are arranged on a side, facing the first shell, of the main body and are respectively close to two opposite ends of the main body in the first direction; the two third engaging units are respectively arranged at ends, away from the main body, of the two third extension units and extend towards each other; and each said third engaging unit comprises a sliding protrusion, and the sliding protrusions extend towards the main body;
the first connector is T-shaped and comprises a first extension unit and a first engaging unit, at least a portion of the first engaging unit extends in the first direction, and at least a portion of the first engaging unit extends in an opposite direction of the first direction;
when the slider is assembled on the first connector, the first engaging unit of the first connector is clamped by the sliding protrusions and the main body to restrain the slider from moving in the third direction or to restrain the slider from moving in an opposite direction of the third direction.

10. The full-wrap protective case according to claim 1, wherein a stop portion is arranged at each of two opposite ends of the first shell or the second shell in a movement direction of the slider, and the stop portions are used for preventing disengagement of the slider.

11. The full-wrap protective case according to claim 1, wherein the first shell or the second shell is provided with elastic engaging parts, the elastic engaging parts are engaged with two opposite ends of an electronic device in a length direction and also engaged with two opposite ends of the electronic device in a width direction.

12. The full-wrap protective case according to claim 11, wherein a first soft pad is arranged on an inner side of the first shell, a second soft pad is arranged on an inner side of the second shell, and in a storage state, the first soft pad and the second soft pad respectively abut against two opposite ends of the electronic device in a thickness direction.
